(19) United States
(12) Patent Application Publication
(10) Pub. No.: US 2010/0141604 A1
(43) Pub. Date: Jun. 10, 2010

(54) RESISTIVE MULTI TOUCH SCREEN

(75) Inventors: Chenguang Cai, Beijing (CN); Liangfeng Xu, Coppell, TX (US); Anping Zhao, Beijing (CN); Antti Salo, Beijing (CN)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 12/330,942

(22) Filed: Dec. 9, 2008

(51) Int. Cl. G06F 3/045

(52) U.S. Cl. 345/174

(57) ABSTRACT

Methods, apparatuses, and systems for processing tactile input received at a display are disclosed. An apparatus may include a display comprising a tactile sensor and a display screen. The tactile sensor may include a top layer comprising a first plurality of resistive strips, wherein each of the resistive strips in the top layer are spaced apart from one another, a bottom layer comprising a second plurality of resistive strips, wherein each of the resistive strips in the bottom layer are spaced apart from one another, and a separator positioned between the first plurality of resistive strips of the top layer and the second plurality of resistive strips of the bottom layer, wherein the tactile sensor is configured to receive a tactile input to cause at least one of the resistive strips of the top layer to contact at least one of the plurality of resistive strips of the bottom layer.

### FIELD

Example embodiments of the invention generally relate to touch screen technology. More specifically, example embodiments of the invention relate to a resistance based multi-point touch screen.

### BACKGROUND

Mobile phones, computers, and other devices typically have displays to visually present information to a user. Touch screen technology may receive and process a single touch or multiple simultaneous touches from a user at a display screen. Single touch screens are often based on resistive technologies that identify user input by measuring a change in resistance caused by a user touching a certain area on the display. Conventionally, single touch screens can only detect a single input from a user at a time, and cannot detect two or more near simultaneous touches.

Multi touch screens are becoming increasingly popular for devices as they can process tactile information input by a user simultaneously touching multiple locations on a display. Three types of conventional multi touch screens include: a capacitive type, a switch matrix type, and an optical type. Known types of multi touch screens, however, are based on complex and expensive technology. The manufacturing of the three types of multi touch screens is more complex than that of resistive touch screens. Multi touch screens also require very complex signal processing methods and very complex processing circuits. Hence, the cost of all the three kinds of known multi touch screens is higher than that of resistive touch screens.

Processing handwriting on a display input by a user can be challenging based on current touch screen technology. Handwriting requires a touch screen having high resolution. To obtain good results, the touch panel and the resolution of the display screen may have about the same resolution. Capacitive type multi touch screens have lower resolution than resistive touch screens, thus they are currently unable to satisfactorily support handwriting input. For the switch matrix and optical type multi touch screens, a higher resolution requires complex manufacturing techniques, signal processing, and circuitry, which results in higher cost.

### BRIEF SUMMARY

The following presents a simplified summary of example embodiments of the invention in order to provide a basic understanding of some example embodiments of the invention. This summary is not an extensive overview, and is not intended to identify key or critical elements or to delineate the scope of the claims. The following summary merely presents some concepts and example embodiments in a simplified form as a prelude to the more detailed description provided below.

Some example embodiments provide for processing multiple simultaneous tactile inputs using resistive touch screen technology.

Some example embodiments of the present disclosure are directed to an apparatus, method and system for sequentially applying an electrical pulse to an electrode of respective resistive strips, the resistive strips being included in one of the top layer and the bottom layer; sequentially measuring resistance across resistive strip pairs as the electrical pulse is being applied to at least one of the resistive strips in a resistive strip pair, wherein each resistive strip pair includes a resistive strip from the top layer and a resistive strip from the bottom layer, detecting a change in the resistance of a first resistive strip pair due to tactile input during sequential resistance measurement, and determining coordinates of the tactile input on the first resistive strip pair.

Additionally, methods, apparatus, and systems in accordance with certain example embodiments of the present disclosure provide a display comprising a tactile sensor and a display screen. The tactile sensor may include a top layer comprising a first plurality of resistive strips, wherein each of the resistive strips in the top layer are spaced apart from one another, a bottom layer comprising a second plurality of resistive strips, wherein each of the resistive strips in the bottom layer are spaced apart from one another, and a separator positioned between the first plurality of resistive strips of the top layer and the second plurality of resistive strips of the bottom layer, wherein the tactile sensor is configured to receive a tactile input to cause at least one of the resistive strips of the top layer to contact at least one of the plurality of resistive strips of the bottom layer.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a user terminal incorporating a multi-touch display screen in accordance with one or more example embodiments of the present disclosure.

FIG. 2 illustrates an exploded view of a multi-touch display screen of a user terminal in accordance with one or more example embodiments of the present disclosure.

FIG. 3 illustrates a front view of both of top and bottom layers of a tactile sensor in accordance with one or more example embodiments of the present disclosure.

FIG. 4 illustrates a front view of a top layer without a bottom layer of a tactile sensor in accordance with one or more example embodiments of the present disclosure.

FIG. 5 illustrates a front view of a bottom layer without a top layer of a tactile sensor in accordance with one or more example embodiments of the present disclosure.

FIG. 6 illustrates a cross sectional view of an embodiment of a tactile sensor in accordance with one or more example embodiments of the present disclosure.

FIG. 7 illustrates a cross sectional view of an embodiment of a tactile sensor in accordance with one or more example embodiments of the present disclosure.

FIG. 8 illustrates electrical pulses being applied to resistive strips of a bottom layer of a tactile sensor in accordance with one or more example embodiments of the present disclosure.

FIG. 9 illustrates resistive strips of a top and bottom layer of a tactile sensor that have been contacted by a user in accordance with one or more example embodiments of the present disclosure.

FIG. 10 illustrates a measuring principle for determining coordinates of a contact point in accordance with one or more example embodiments of the present disclosure.

FIG. 11 illustrates a method performed by a user terminal in accordance with one or more example embodiments of the present disclosure.

### DETAILED DESCRIPTION

In the following description of the various embodiments, reference is made to the accompanying drawings, which form a part hereof, and in which is shown by way of illustration various embodiments in which one or more example embodiments of the invention may be practiced. It is to be understood that other embodiments may be utilized and structural and functional modifications may be made without departing from the scope of the present invention.

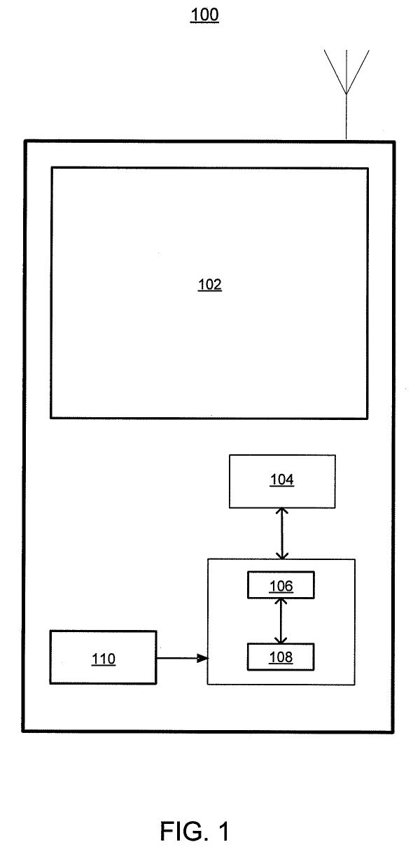

FIG. 1 illustrates a user terminal 100 incorporating a multi-touch display screen 102 in accordance with one or more example embodiments of the present disclosure. The user terminal 100 may be a mobile communication device, as illustrated, or may be a computer, a personal digital assistant, a watch, an Internet browser device, a wired or wireless communication device, combinations thereof, and/or other devices that display text, graphics video, and/or any combination thereof to a user. In the depicted example, the user terminal 100 includes a multi-touch display screen 102, a display generator 104, a processor 106, memory 108 or other computer readable media and/or other storage, and user interface 110. The user interface 110 may include a keypad, touch screen, voice interface, four arrow keys, joy-stick, data glove, mouse, roller ball, touch screen, or other suitable device for receiving input from a user to control the user terminal 100.

Computer executable instructions and data used by processor 106 and other components within user terminal 100 may be stored in the memory 108 in order to carry out any of the method steps and functions described herein. The memory 108 may be implemented with any combination of read only memory modules or random access memory modules, optionally including both volatile and nonvolatile memory. Also, some or all of user terminal 100 computer executable instructions may be embodied in hardware or firmware (not shown). The user terminal 100 may also have other components that are not depicted, or the functionality of the depicted components may be integrated with one another or separated into further components local or remote to the user terminal 100. For instance, the processor 106 and the display generator 104 may be combined, or the operations of the processor 106 may be performed by separate processors remote or local to the user terminal 100.

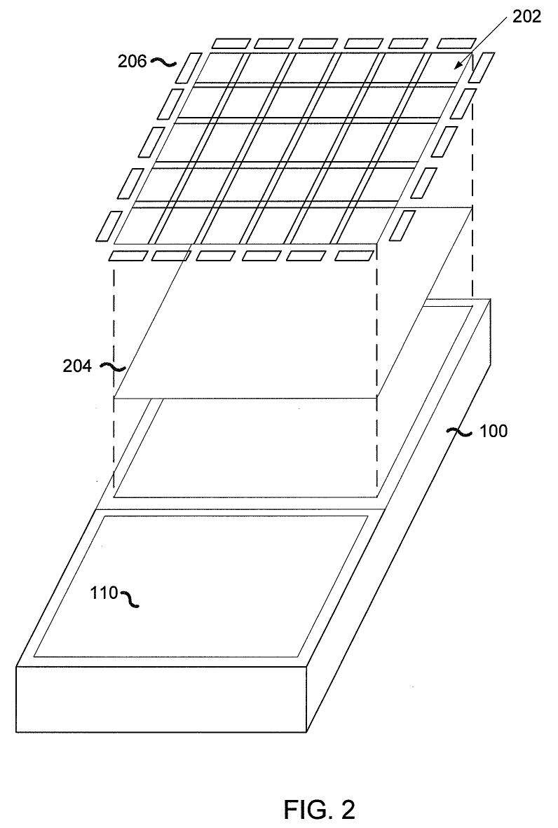

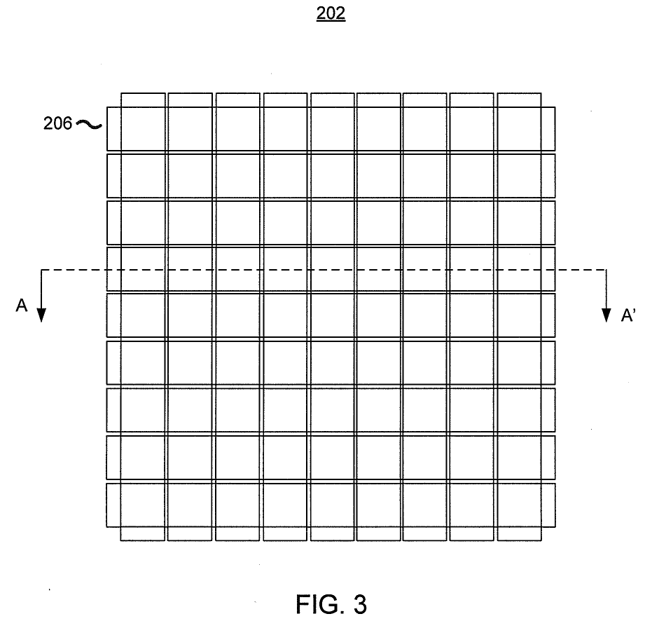

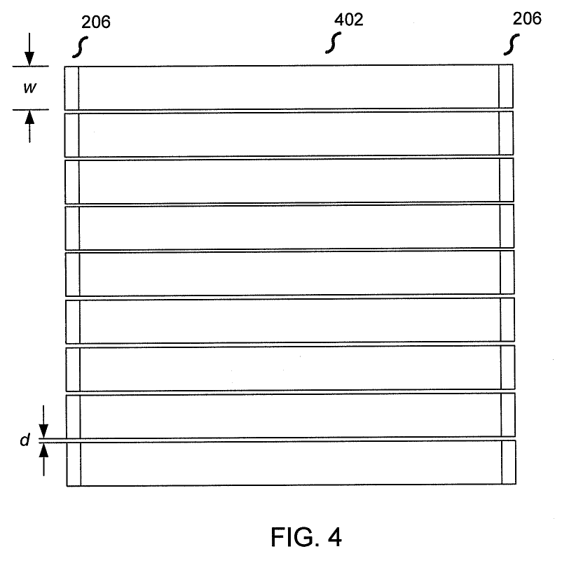

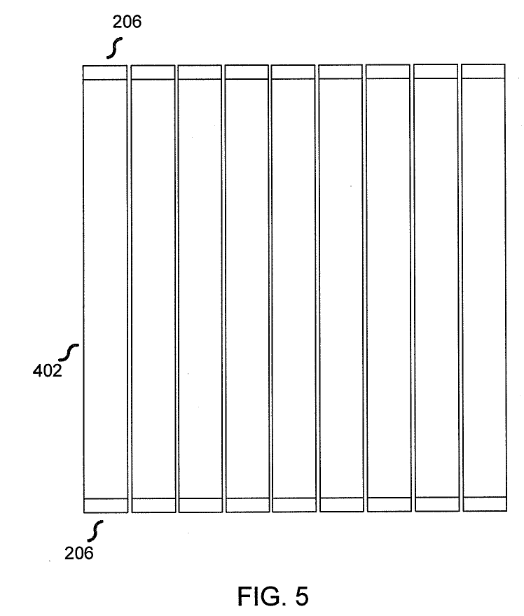

FIG. 2 illustrates an exploded view of the multi-touch display screen 102 of a user terminal 100 in accordance with one or more example embodiments of the present disclosure. In various embodiments, the multi-touch display screen 102 may include a tactile sensor 202 and a display screen 204. The multi-touch display screen 102 may be positioned in a housing of the user terminal 100 with the tactile sensor 202 being external to the display screen 204. The tactile sensor 202 may include multiple electrodes 206 surrounding two layers of resistive strips. The resistive strips may comprise translucent conductive materials, such as, but not limited to, Indium Tin Oxide (ITO). FIG. 3 illustrates a front view of overlapping top and bottom layers of the tactile sensor 202, FIG. 4 illustrates a front view of the top layer of resistive strips without the bottom layer of resistive strips, and FIG. 5 illustrates a front view of the bottom layer without the top layer. It is noted that the order of the top layer and the bottom layer may be reversed, with the bottom layer being on top and the top layer being on the bottom.

With reference to FIGS. 4 and 5, each of the top and bottom layers may include a row of resistive strips 402. An electrode 206 may be positioned at each end of each resistive strip 402. The resistive strips 402 may be bar-shaped and may be perpendicular to the electrodes 206. Referring to FIG. 4, the resistive strips 402 may be of width w and each resistive strip 402 in a layer (i.e., in the top layer or in the bottom layer) may be separated from adjacent resistive strips by a gap of distance d. Width w may vary adjusted to suit different designs, but may be as narrow as the width of a nib of a stylus (e.g., 2 millimeters) or as wide or wider than the width of a finger (e.g., 20 millimeters). The gap of distance d may vary adjusted to suit different designs, but may be as narrow as possible depending on manufacturing limitations. The width w may be adjusted, for example, based on the average size of the width of a finger or based on the width of a stylus used to touch the multi-touch display screen 102. Although the resistive strip 402 having arbitrary widths w can be designed, the multi-touch display screen 102 may be designed such that at least two or more resistive strips 402 are used per layer (e.g., at least two resistive strips in the top layer and at least two resistive strips in the bottom layer).

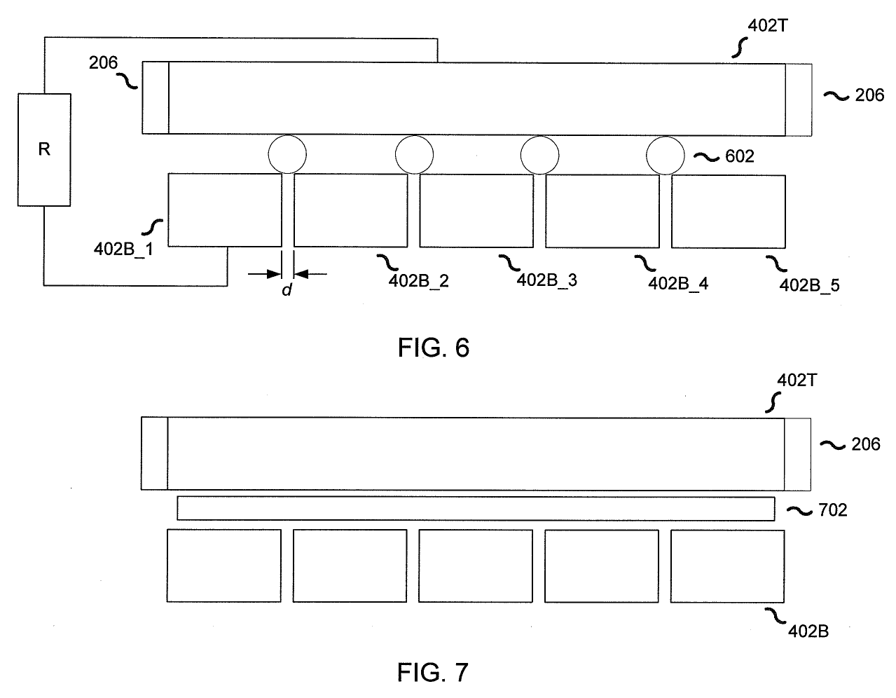

FIGS. 6 and 7 illustrate cross sectional views of two embodiments of the tactile sensor 202 in accordance with one or more example embodiments of the present disclosure. FIG. 6 illustrates a cross sectional view of the tactile sensor 202 along line A-A′ in FIG. 3 in accordance with a first embodiment, and FIG. 7 illustrates a cross sectional view of the tactile sensor 202 along line A-A′ in FIG. 3 in accordance with a second embodiment. FIGS. 6 and 7 illustrate different embodiments of separators that may be used to separate the top and bottom layers. FIG. 6 describes separators that can be spacers and FIG. 7 describes separators that can be a resistive layer.

FIG. 6 illustrates spacers 602 positioned between the resistive strips 402T of the top layer and the resistive strips 402B of the bottom layer. The spacers 602 may contact each of the bottom and top layer resistive strips, or may be attached to one of the bottom and top layer resistive strips. The spacers 602 may be positioned to cover each gap of distance d between the resistive strips 402B in the bottom layer and beneath the resistive strips 402T of the top layer. The spacers 602 may be insulators. The spacers 602 may electrically and physically isolate the top layer and the bottom layer to prevent the two layers from contacting without receiving a touch from a user. The spacers 602 also may act as partitions so that contact may occur between the contacted strips in the top and bottom layers. Where there is no contact between the layers, the processor 106 may measure a high resistance between any resistive strip 402T from the top layer and any resistive strip 402B from the bottom layer.

When a user contacts the top layer, a bottom surface of resistive strip 402T of the top layer may deflect to contact a top surface of resistive strip 402B of the bottom layer. For example, a user may press resistive strip 402T to cause the bottom surface of resistive strip 402T to contact the resistive strip 402B_2. This contact can produce a change in resistance between the contacted pair of resistive strips 402 at the contact location, where a resistive strip pair may include a resistive strip 402T from the top layer and a resistive strip 402B from the bottom layer.

The force of the contact applied by the user may adjust an electrical resistance between the resistive strips in a resistive strip pair. Pressing the flexible resistive strip 402T can create electrical contact between a top layer resistive strip 402T and a bottom layer resistive strip 402B. As discussed in further detail below, the user terminal 100 may scan the resistance of resistive strip pairs by sequentially applying electrical pulses at the respective electrodes 206 to determine at which resistive strip pair the tactile input was received. In addition to spacers 602, the tactile sensor 202 also may include a resistive layer between the top layer and the bottom layer.

FIG. 7 illustrates a resistive layer 702 positioned between the resistive strips 402T of the top layer and the resistive strips 402B of the bottom layer in accordance with example embodiments of the present disclosure. The resistive layer 702 may be a material having a property where its resistance may change in response to a touch. For example, the material may be a piezoresistive material.

When a user makes contact with a resistive strip 402T of the top layer, a bottom surface of the top layer resistive strip 402T may come into contact with the resistive layer 702 and may cause the resistive layer 702 to contact a top surface of resistive strip 402B of the bottom layer. Accordingly, the resistive strip 402T may indirectly contact the resistive strip 402B through the resistive layer 702. This contact can change the electrical resistance at the contact location. As discussed in further detail below, the user terminal 100 may scan the resistance of resistive strip pairs by sequentially applying electrical pulses at the respective electrodes 206 to determine at which resistive strip pair the tactile input was received. It is noted that FIG. 6 illustrates only spacers 602, and FIG. 7 illustrates only resistive layer 702, but a combination of spacers 602 and resistive layers 702 also may be used.

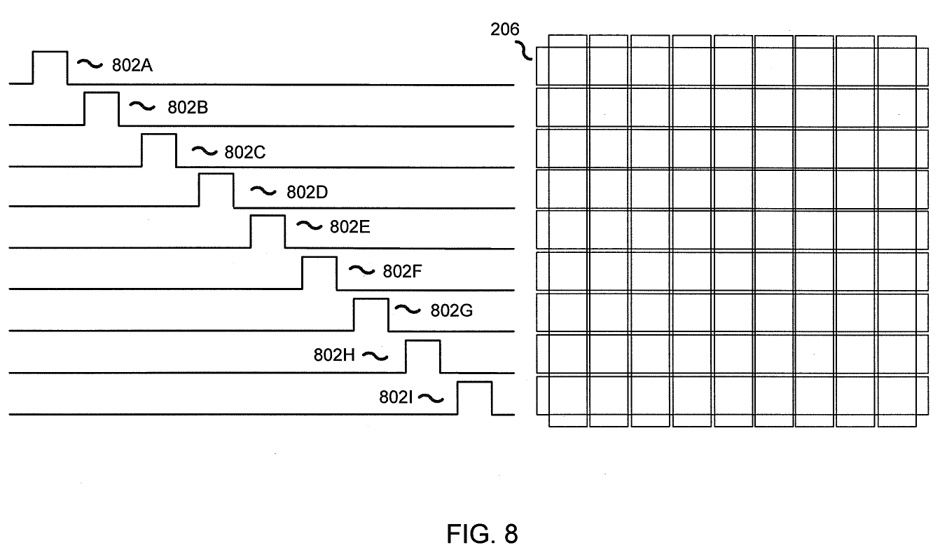

FIG. 8 illustrates electrical pulses being applied to resistive strips of the bottom layer of a tactile sensor in accordance with example embodiments of the present disclosure. Electrical pulses 802A-802I may be sequentially applied to separate electrodes 206 of the bottom layer. The processor 106 may instruct the display generator 104 to sequentially apply a series of electrical pulses 802 to the electrodes 206 of the respective resistive strips 402T in the bottom layer. After a first electrical pulse 802A is applied to a first electrode 206 in the bottom layer, the display generator 104 may wait for a predetermined amount of time to expire and may then apply a second electrical pulse 802B to a second electrode 206, and so forth until a pulse has been applied to each of the electrodes 206 in the bottom layer. Once an electrical pulse 802 has been applied to each electrode 206 in the bottom layer, the display generator 104 may return to the first electrode and may sequentially apply another round of electrical pulses 802 to each of the electrodes 206 in the bottom layer. The scanning frequency at which the pulses 802 are applied to a particular electrode 206 may depend on the number of resistive strips 402 of the bottom layer. In an example embodiment, each resistive strip may be scanned every 5 milliseconds. The resistive strips 402 also may be scanned more or less frequently.

In an example, FIG. 8 illustrates electrical pulse 802A being applied to the uppermost electrode 206, electrical pulse 802B being applied to the next uppermost electrode 206, and so forth until electrical pulse 802I is applied to the last electrode 206. Thereafter, the display generator 104 may repeat and sequentially apply the electrical pulses 802A-802I another time. The electrical pulses 802A-802I may be applied at unique times for use in determining which pair of resistive strips 402, if any, has been contacted by a user. Similar electrical pulses (not shown) may be sequentially applied to each of the electrodes 206 of the top layer in the same manner as the pulses are described as being applied to the bottom layer in FIG. 8.

When an electrical pulse 802 is being applied to a particular resistive strip 402 in a layer, the processor 106 may instruct the display generator 104 to sequentially measure the resistance between the resistive strip 402T in the top layer and each of the resistive strips 402B in the bottom layer. Once the resistance has been measured between the resistive strip 402T in the top layer and each of the resistive strips 402B in the bottom layer, the display generator 104 may move to the next resistive strip in the top layer and sequentially measure the resistance between that resistive strip in the top layer and each of the resistive strips in the bottom layer, until the resistance between each of the resistive strips in the top layer have been and each of the resistive strips in the bottom layer have been determined. Once completed, the processor 106 may instruct the display generator 104 to repeat the measuring process.

In an example, referring again to FIG. 6, the processor 106 may instruct the display generator 104 to apply an electrical pulse 802 to electrode 206 to resistive strip 402T in the top layer and to sequentially measure the resistance between the resistive strip 402T and each of the resistive strips 402B_1 to 402B_5. When measuring the resistance between resistive strip 402T and resistive strip 402B_1, the display generator 104 may allow resistive strips 402B_2 to 402B_5 to float (i.e., be kept in a state of high resistance). To measure the resistance between resistive strip 402T and resistive strip 402B_2, the display generator 104 may allow resistive strips 402B_1 and 402B_3 to 402B_5 to float, and so forth. Floating the resistive strips 402 not being measured may reduce or eliminate current bypass issues. For example, if there is a touch between strip 402T and 402B_2 when measuring the resistance between resistive strip 402T and resistive strip 402B_1, coupling resistive strip 402B_2 to ground, for instance, would cause some electrical current to bypass resistive strip 402T through the resistance between strip 402T and 402B_2. Floating the resistive strips 402 not being measured (e.g., resistive strips 402B_2 to 402B_5 in this example) may reduce or eliminate this current bypass effect.

Once measured, the processor 106 may respectively compare the resistance measurement for each pair of resistive strips 402 (e.g., the resistance between resistive strip 402T and resistive strip 402B_1, the resistance between resistive strip 402T and resistive strip 402B_2, etc.) to a stored resistance value for the pair. The stored resistance value may be a contactless resistance measurement between each pair of resistive strips 402.

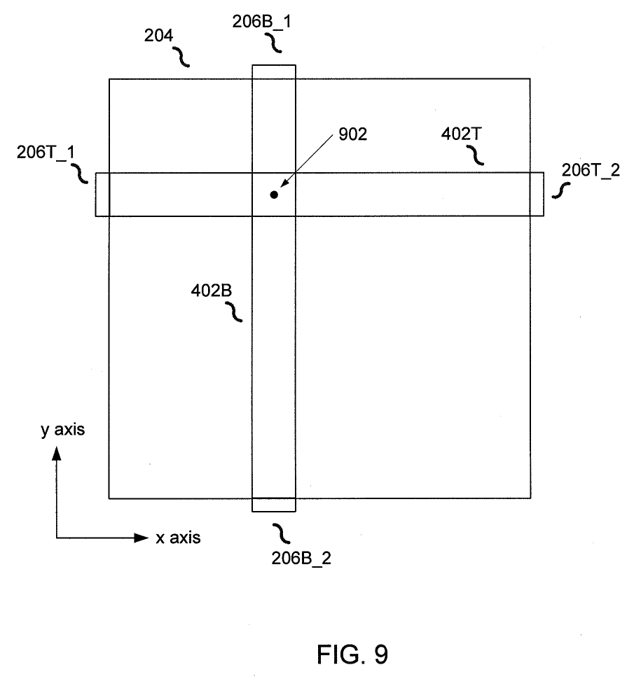

FIG. 9 illustrates resistive strips 402 of the top and bottom layer of a tactile sensor 202 that have been contacted by a user in accordance with one or more example embodiments of the present disclosure. This figure illustrates the display screen 204 and a resistive strip 402T of the top layer and a resistive strip 402B of the bottom of the tactile sensor 202, whereas the remaining resistive strips 402 have been omitted for clarity. When a user presses on a particular combination of resistive strips 402 of the tactile sensor 202, such as at contact point 902, the resistance characteristics of these resistive strips 402 may change, whereas the resistance characteristics of the other resistive strips that were not contacted may remain substantially the same. By sequentially applying the electrical pulses 802 to the electrodes 206 of the resistive strips 402T and 402B, the processor 106 can identify the resistive strip pair that the user contacted by measuring the resistance of pairs of resistive strips 402 and identifying the resistive strips where there has been a change in resistance due to contact (e.g., between resistive strips 402T and 402B at contact point 902). By identifying the pair of resistive strips 402 where the resistance has changed as compared with a stored resistance value, the user terminal 100 may determine the approximate location of the tactile input. The user terminal 100 may then determine coordinates (e.g., Cartesian coordinates) of the contact location 902 of the contacted resistive strip pair.

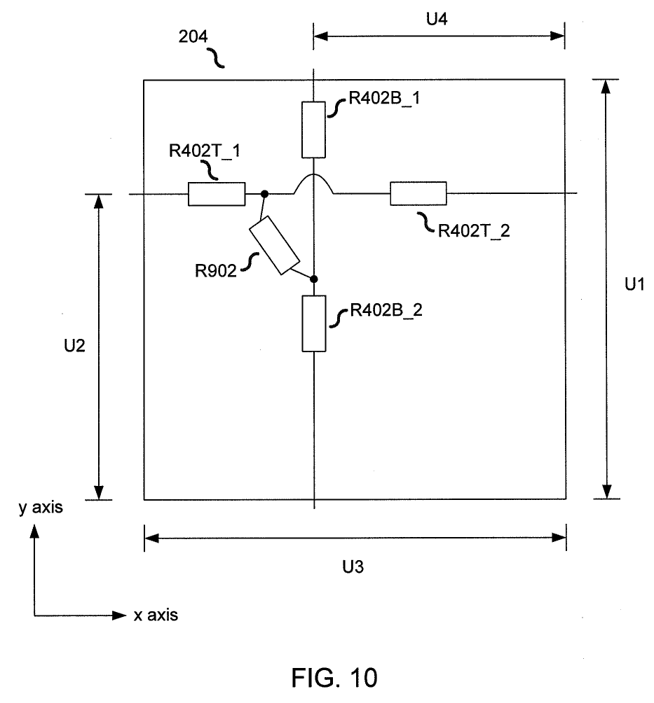

FIG. 10 illustrates a measuring principle for determining coordinates of the contact point in accordance with one or more example embodiments of the present disclosure. The following discussing refers to both FIGS. 9 and 10. To determine a y coordinate along the y axis of FIGS. 9 and 10, the processor 106 may apply an electrical pulse 802 of voltage U1 to create a voltage gradient across electrodes 206B_1 and 206B_2 and may measure a voltage U2 at electrode 206T_1. The voltage U2 may be measured at electrode 206T_1 because of contact between the resistive strip 402T in the top layer and the resistive strip 402B in the bottom layer. Because each strip 402 is resistive, a resistive ratio of the resistive strip 402 along x axis or y axis may be constant. Based on the resistive ratio, the processor 106 may measure the voltage U2 at electrode 206T_1, where

$$U 2 = U 1 * ( \frac{R 402 B\_ 2}{R 402 B\_ 1 + R 402 B\_ 2} ) , where R 402 B\_ 2 + R 402 B\_ 1 = R 402 B .$$

The voltage U2 may represent the distance along the y axis of the user contact (i.e., a y coordinate) between electrodes 206B_1 and 206B_2. Also, to determine an x coordinate along the x axis of FIGS. 9 and 10, the processor 106 may apply an electrical pulse 802 of voltage U3 to create a voltage gradient across electrodes 206T_1 and 206T_2 and may measure a voltage U4 at electrode 206B_1. The processor 106 may measure the voltage U4 at electrode 206B_1, where

$$U 4 = U 3 * ( \frac{R 402 T\_ 2}{R 402 T\_ 1 + R 402 T\_ 2} ) , where R 402 T\_ 2 + R 402 T\_ 1 = R 402 T .$$

The voltage U4 may represent the distance along the x axis of the user contact (i.e., the x coordinate) between electrodes 206B_1 and 206B_2. The x and y coordinates on the multi-touch display screen 102 may also be determined using other methods. The processor 106 also may use conventional methods to measure touch force.

Identifying pairs of resistive strips 402 where resistance has changed also may be used to process multiple simultaneous tactile inputs by a user. Because each of the resistive strips 402 in a layer are separated from one another by gap d and the manner in which the resistive strips 402 are scanned to measure resistance, the user terminal 100 may identify one or more pairs of resistive strips where there is a change in resistance as compared with a stored resistance value for the pair to identify one or more contact points (i.e., when there is not a touch, the pair of resistive strips may have a high or infinite resistance as there is no electrical contact). Then, the user terminal 100 may calculate the coordinates of each touch tactile input using the measuring principle discussed above with reference to FIG. 10.

For instance, a user may contact the tactile sensor 202 at different locations at about the same time. The user terminal 100 may sequentially apply the electrical pulses 802 to the electrodes 206 to identify which pairs of resistive strips 402 have been contacted based on a change in resistance of the pair, and hence may identify different resistive strip pairs the user has contacted. Because the width of the resistive strip 402 can be less than or the same size as the touch point (e.g., a stylus or a finger), more than one tactile input may not be located on the same resistive strip pair. According to scanning method illustrated in FIG. 8, each pair of resistive strip pair having a change in contact resistance can be identified. Then according to method illustrated in FIG. 10, the user terminal 100 may calculate the coordinate of each touch tactile input. Thus, a resistive touch screen may be used to detect multiple simultaneous or near simultaneous tactile inputs from a user.

Additionally, the processor 106 may use the determined coordinates to perform further processing. For example, the display generator 104 may display a plurality of icons on the display screen 204. The processor 106 may compare the coordinates of the tactile input with the location at which each of the icons is displayed. The processor 106 may determine that the location of the tactile input is the user's selection of the icon closest to the tactile input or if the tactile input is within a certain distance from the icon, such as within a certain radius or selection area. The selection area may depend on the number of displayed icons. For instance, each icon may be associated with a rectangular area surrounding the area. The processor 106 may then execute a software program or other computer readable media that is associated with the closest icon or within the selection area.

Further, the processor 106 may use the determined coordinate location as a handwriting input. The processor 106 may use the measuring principle for determining a sequence of coordinates discussed above in FIG. 10 as the user provides tactile handwriting input. The processor 106 may process the handwriting input received at the tactile sensor 202 to identify a sequence of coordinates corresponding to the tactile handwriting input.

In another example, the user terminal 100 may electrically connect together the electrodes 206 on the same side for each of the top and bottom layers. For instance, referring to FIG. 4, the user terminal 100 may electrically connect together the electrodes 206 depicted on the left into a first group, and may electrically connect together the electrodes 206 depicted on the right into a second group. Referring to FIG. 5, the user terminal 100 may electrically connect together the electrodes 206 depicted on the top into a third group, and may electrically connect together the electrodes 206 depicted on the bottom into a fourth group. The tactile sensor 202 may then detect handwriting as in conventional resistive single touch screen. For instance, the processor 106 may measure a voltage gradient across the top layer with the bottom layer acting as a return layer to measure a distance to the tactile input along the y axis and may measure a voltage gradient across the bottom layer with the top layer acting as a return layer to measure a distance to the tactile input along the x axis.

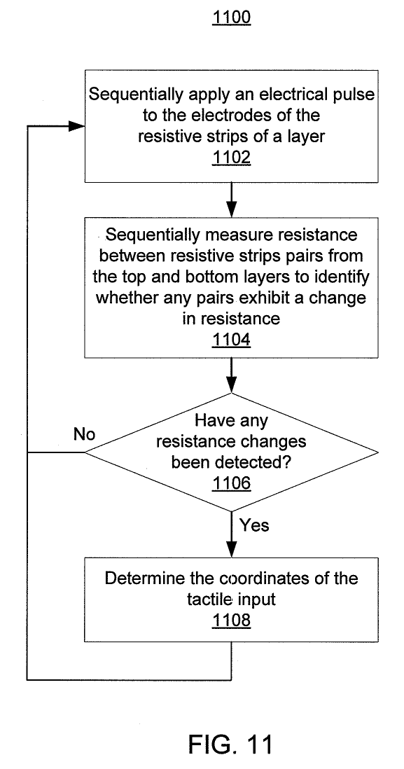

FIG. 11 illustrates a flow diagram 1100 performed by the user terminal 100 in accordance with one or more example embodiments of the present disclosure. In block 1102, the processor 106 of the user terminal 100 may instruct the display generator 104 to sequentially apply electrical pulses 802 to the electrodes 206 of the resistive strips 402 in a layer. For instance, the display generator 104 may sequentially apply electrical pulses 802 to each of the electrodes 206 of the resistive strips 402T in the top layer while the resistive strips 402B of the bottom layer not being measured can be floated. In another example, the display generator 104 may sequentially apply electrical pulses 802 to each of the electrodes 206 of the resistive strips 402B of the bottom layer while the resistive strips 402T of the top layer not being measured are floated. Once an electrical pulse 802 has been applied to the electrodes 206 for each of the resistive strips in either the top or bottom layer, the display generator 104 may return to the electrodes 206 of the first resistive strip 402 in the layer and may sequentially apply the electrical pulses another round of electrical pulses 802.

In block 1104, the processor 106 of the user terminal 100 may instruct the display generator 104 to sequentially measure the resistance between resistive strip pairs from the top and bottom layers to identify whether any pairs exhibit a change in resistance. In an example, when an electrical pulse 802 is being applied to a particular resistive strip 402T in the top layer, the display generator 104 may measure the resistance between particular resistive strip 402T and each of the resistive strips 402B in the bottom layer. A resistive measurement may be made as the electrical pulses 802 are sequentially applied to the different resistive strips 402 to measure the resistance between all combinations of resistive strips 402T in the top layer and resistive strips 402B in the bottom layer.

In block 1106, the processor 106 may determine whether any resistance changes have been detected for any pairs of resistive strips 402. For instance, the processor 106 may access resistance values stored in memory 108 for each resistive strip pair and may compare the measured resistance to the stored resistance for each pair to identify any changes. The stored resistance values may be based on a contactless resistance measurement between each of the resistive strip pairs. The processor 106 may detect that a particular resistive strip pair is being contacted by a user if there is a change in the resistance when compared with the contactless resistance measurement. If no change in resistance is detected for any of the resistive strip pairs, the flow diagram 1100 may return to block 1102. If any change in resistance is detected for one or more resistive strip pairs, the flow diagram 1100 may continue to block 1108.

In block 1108, the processor 106 may determine the coordinates of the tactile input on the one or more resistive strip pairs experiencing the change in resistance. The processor 106 may determine the coordinates (e.g., Cartesian coordinates) using the measuring principle discussed above with reference to FIG. 10. The processor 106 may use the coordinates to perform further processing. For instance, the processor 106 may determine that the user selected a displayed icon closest to the Cartesian coordinates or may interpret the input as handwriting of the user. The processor 106 may then execute a software program associated with the closest icon. The flow diagram 1100 may then return to block 1102.

Accordingly, some example embodiments of the present disclosure incorporate resistive touch screen technology to implement a multi-touch display screen. These example embodiments may advantageously avoid expensive manufacturing techniques and do not involve complex signal processing methods or complex processing circuitry. The multi touch screen in accordance with some example embodiments of the present disclosure is able to process handwriting input by a user using resistive touch screen technology.

The foregoing description was provided with respect to processing multiple user input by using resistive screen technology. It is understood that the principles described herein may be extended to any device that displays information to a user and requests tactile user input.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a display comprising a tactile sensor and a display screen, wherein the tactile sensor comprises:
a top layer comprising a first plurality of resistive strips, wherein each of the resistive strips in the top layer is spaced apart from one another,
a bottom layer comprising a second plurality of resistive strips, wherein each of the resistive strips in the bottom layer are spaced apart from one another, and
a separator positioned between the first plurality of resistive strips of the top layer and the second plurality of resistive strips of the bottom layer, wherein the tactile sensor is configured to receive a tactile input to cause a first resistive strip of the top layer to contact a second resistive strip of the bottom layer.

2. The apparatus of claim 1, wherein each of the first plurality of resistive strips are arranged perpendicular to the second plurality of resistive strips.

3. The apparatus of claim 1, wherein an electrode is positioned at either end of each resistive strip.

4. The apparatus of claim 1, wherein the separator comprises a spacer, and the first resistive strip of the top layer is configured to directly contact the second resistive strip.

5. The apparatus of claim 1, wherein the separator comprises a resistive layer, and the first resistive strip is configured to indirectly contact the second resistive strip through the resistive layer.

6. The apparatus of claim 1, further comprising:
a processor;
a memory having stored therein computer readable instructions, that when executed, cause the apparatus to:
sequentially apply an electrical pulse to an electrode of respective resistive strips included in one of the top layer and the bottom layer;
sequentially measure resistance across resistive strip pairs as the electrical pulse is being applied to at least one of the resistive strips in a resistive strip pair, wherein each resistive strip pair includes a resistive strip from the top layer and a resistive strip from the bottom layer;
detect a change in resistance of a first resistive strip pair due to tactile input during sequential resistance measurement; and
determine coordinates of the tactile input on the first resistive strip pair.

7. A method comprising:
sequentially applying an electrical pulse to an electrode of respective resistive strips included in one of a top layer and a bottom layer;
sequentially measuring resistance across resistive strip pairs as the electrical pulse is being applied to at least one of the resistive strips in a resistive strip pair, wherein each resistive strip pair includes a resistive strip from the top layer and a resistive strip from the bottom layer;
detecting a change in resistance of a first resistive strip pair due to tactile input during sequential resistance measurement; and
determining coordinates of the tactile input on the first resistive strip pair.

8. The method of claim 7, wherein the detecting of the change further comprises comparing a stored resistance value obtained from a contactless resistance measurement with a measured resistance of the first resistive strip pair to detect the change in the resistance.

9. The method of claim 7, wherein the determining of the coordinates further comprises:
applying voltage across electrodes of a first resistive strip of the first resistive strip pair; and
determining a voltage at a first electrode of a second resistive strip of the first resistive strip pair while the voltage is applied across the electrodes of the first resistive strip, wherein the first resistive strip is included in the bottom layer and the second resistive strip is included in the top layer.

10. The method of claim 7, wherein the determining of the coordinates further comprises:
applying voltage across electrodes of a first resistive strip of the first resistive strip pair; and
determining a voltage at a first electrode of a second resistive strip of the first resistive strip pair while the voltage is applied across the electrodes of the first resistive strip, wherein the first resistive strip is included in the top layer and the second resistive strip is included in the bottom layer.

11. The method of claim 7, further comprising allowing the resistive strips not in the resistive strip pair to float.

12. The method of claim 7, further comprising:
causing display of a plurality of icons, wherein each icon is associated with a respective selection area;
determining that the coordinates are within a first selection area associated with a first icon; and
executing a software program associated with the first icon.

13. One or more computer readable media storing computer-executable instructions which, when executed by a processor, cause the processor to perform a method comprising:
sequentially applying an electrical pulse to an electrode of respective resistive strips included in one of a top layer and a bottom layer;
sequentially measuring resistance across resistive strip pairs as the electrical pulse is being applied to at least one of the resistive strips in a resistive strip pair, wherein each resistive strip pair includes a resistive strip from the top layer and a resistive strip from the bottom layer;
detecting a change in resistance of a first resistive strip pair due to tactile input during sequential resistance measurement; and
determining coordinates of the tactile input on the first resistive strip pair.

14. The one of or more computer readable media of claim 13, wherein the detecting of the change further comprises comparing a stored resistance value obtained from a contactless resistance measurement with a measured resistance of the first resistive strip pair to detect the change in the resistance.

15. The one of or more computer readable media of claim 13, wherein the determining of the coordinates further comprises:
applying voltage across electrodes of a first resistive strip of the first resistive strip pair; and
determining a voltage at a first electrode of a second resistive strip of the first resistive strip pair while the voltage is applied across the electrodes of the first resistive strip, wherein the first resistive strip is included in the bottom layer and the second resistive strip is included in the top layer.

16. The one of or more computer readable media of claim 13, wherein the determining of the coordinates further comprises:
applying voltage across electrodes of a first resistive strip of the first resistive strip pair; and
determining a voltage at a first electrode of a second resistive strip of the first resistive strip pair while the voltage is applied across the electrodes of the first resistive strip, wherein the first resistive strip is included in the top layer and the second resistive strip is included in the bottom layer.

17. The one of or more computer readable media of claim 13, comprising further computer-executable instructions that, when executed, cause the processor to perform a method comprising:
causing display of a plurality of icons, wherein each icon is associated with a respective selection area;
determining that the coordinates are within a first selection area associated with a first icon; and
executing a software program associated with the first icon.

18. An apparatus comprising:
a processor;
a memory having stored therein computer readable instructions, that when executed, cause the apparatus to:
sequentially apply an electrical pulse to an electrode of respective resistive strips included in one of a top layer and a bottom layer;
sequentially measure resistance across resistive strip pairs as the electrical pulse is being applied to at least one of the resistive strips in a resistive strip pair, wherein each resistive strip pair includes a resistive strip from the top layer and a resistive strip from the bottom layer;
detect a change in resistance of a first resistive strip pair due to tactile input during sequential resistance measurement; and
determine coordinates of the tactile input on the first resistive strip pair.

19. The apparatus of claim 18, wherein, to determine a first coordinate of the tactile input, the computer readable instructions, when executed, cause the apparatus to:
apply voltage across electrodes of a first resistive strip of the first resistive strip pair; and
determine a voltage at a first electrode of a second resistive strip of the first resistive strip pair while the voltage is applied across the electrodes of the first resistive strip, wherein the first resistive strip is included in the top layer and the second resistive strip is included in the bottom layer.

20. The apparatus of claim 18, wherein, to determine a first coordinate of the tactile input, the computer readable instructions, when executed, cause the apparatus to:
apply voltage across electrodes of a first resistive strip of the first resistive strip pair; and
determine a voltage at a first electrode of a second resistive strip of the first resistive strip pair while the voltage is applied across the electrodes of the first resistive strip, wherein the first resistive strip is included in the bottom layer and the second resistive strip is included in the top layer.

21. The apparatus of claim 18, wherein, to detect the change, the computer readable instructions, when executed, cause the apparatus to compare a stored resistance value obtained from a contactless resistance measurement with a measured resistance of the first resistive strip pair.

22. An apparatus comprising:
means for sequentially applying an electrical pulse to an electrode of respective resistive strips included in one of a top layer and a bottom layer;
means for sequentially measuring resistance across resistive strip pairs as the electrical pulse is being applied to at least one of the resistive strips in a resistive strip pair, wherein each resistive strip pair includes a resistive strip from the top layer and a resistive strip from the bottom layer;
means for detecting a change in resistance of a first resistive strip pair due to tactile input during sequential resistance measurement; and
means for determining coordinates of the tactile input on the first resistive strip pair.
